(19) United States
(12) Patent Application Publication
(10) Pub. No.: US 2006/0202972 A1
(43) Pub. Date: Sep. 14, 2006

(54) Display apparatus

(76) Inventors: Dae-jin Kim, Uiwang-si (KR); Ki-hyub Sung, Suwon-si (KR); Hyun-yong Choi, Chuncheon-si (KR)

Correspondence Address: STANZIONE & KIM, LLP, 919 18TH STREET, N.W., SUITE 440, WASHINGTON, DC, 20006, US

(21) Appl. No.: 11/357,141

(22) Filed: Feb. 21, 2006

(30) Foreign Application Priority Data
Mar. 8, 2005 (KR) 2005-18978

(51) Int. Cl. G09G 5/00

(52) U.S. Cl. 345/173

(57) ABSTRACT

A display apparatus includes a display panel to display a picture thereon, a front cover and a rear cover to support the display panel, a pen unit movable on the display panel and including a light generator to emit light and a supersonic wave generator to emit a supersonic wave, a light sensor provided at the front cover to detect the light emitted from the light generator, a first supersonic wave sensor provided at the front cover to detect the supersonic wave emitted from the supersonic wave generator, and disposed adjacent to the light sensor to measure a distance from the pen unit using a time difference between when the light sensor detects the light and when the first supersonic wave generator detects the supersonic wave, a second supersonic wave sensor provided at the front cover to detect the supersonic wave emitted from the supersonic wave generator, and spaced apart from the first supersonic wave sensor to measure a relative distance from the pen unit using a time difference between when the first supersonic wave sensor and the second wave sensor detect the supersonic wave, and a controller to receive a detecting signal from each of the first supersonic wave sensor, the second supersonic wave sensor, and the light sensor, and to detect position information of the pen unit based on the received detecting signals. Accordingly, the display apparatus performs a tablet function and reduces production costs by using a simple display panel.

### CROSS-REFERENCE TO RELATED APPLICATIONS

This application claims the benefit under 35 U.S.C. § 119 of Korean Patent Application No. 2005-18978, filed on Mar. 8, 2005, in the Korean Intellectual Property Office, the disclosure of which is incorporated herein in its entirety.

### BACKGROUND OF THE INVENTION

1. Field of the Invention

The present general inventive concept relates to a display apparatus, and more particularly, to a display apparatus having an improved configuration to realize a tablet function.

2. Description of the Related Art

A display apparatus refers to a television, a monitor, etc., which displays a picture thereon. The display apparatus typically employs a flat display panel, such as a liquid crystal display (LCD) or a plasma display panel (PDP), to save an installation space.

Recently, a display apparatus performing a tablet function has been developed, which inputs various information on a screen by using an electric pen or the like.

The display apparatus having such a tablet function is disclosed in Korean Patent First Publication No. 10-2003-65713 and in Korean Utility Model No. 20-301821. The display apparatus having a conventional tablet function comprises a touch screen as the display panel to display a picture. A user may input desired information on the touch screen with the electric pen, etc.

However, the display apparatus having the conventional tablet function is mounted with the touch screen which is relatively expensive compared to the display panel for general display apparatuses, thereby increasing the price of the display apparatus considerably.

### SUMMARY OF THE INVENTION

Accordingly, the present general inventive concept provides a display apparatus which performs a tablet function and reduces production costs by using a simple display panel.

Additional aspects and utilities of the present general inventive concept will be set forth in part in the description which follows and, in part, will be obvious from the description, or may be learned by practice of the general inventive concept.

The foregoing and/or other aspects of the present general inventive concept are achieved by providing a display apparatus comprising a display panel to display a picture thereon, a front cover and a rear cover to support the display panel, a pen unit movable on the display panel and comprising a light generator to emit light and a supersonic wave generator to emit a supersonic wave, a light sensor provided at the front cover to detect the light emitted from the light generator, a first supersonic wave sensor provided at the front cover to detect the supersonic wave emitted from the supersonic wave generator and disposed adjacent to the light sensor to measure a distance from the pen unit using a time difference between when the light sensor detects the light and when the first supersonic wave sensor detects the supersonic wave, a second supersonic wave sensor provided at the front cover to detect the supersonic wave emitted from the supersonic wave generator and spaced apart from the first supersonic wave sensor to measure a relative distance from the pen unit using a time difference between when the first supersonic wave sensor and the second supersonic wave sensor detect the supersonic wave, and a controller to receive a detecting signal from each of the first supersonic wave sensor, the second supersonic wave sensor, and the light sensor, and to detect position information of the pen unit based on the received detecting signals.

The display apparatus may further comprise a first sensor housing provided at the front cover to accommodate the light sensor and the first supersonic wave sensor, and a second sensor housing provided at the front cover to accommodate the second supersonic wave sensor.

The first sensor housing and the second sensor housing may be respectively provided on upper left and right parts of the front cover.

The pen unit may further comprise a control button to control operation of the light generator and the supersonic wave generator.

The display apparatus may further comprise a protection plate provided at a front surface of the display panel to protect the display panel from contact with the pen unit.

The display apparatus may further comprise one or more protection plate supporters projecting from the front cover in a central direction of the display panel to detachably support the protection plate at the front surface of the display panel.

The controller may transmit the position information of the pen unit to an external video signal control apparatus to control a video signal of the display panel to display movement of the pen unit on the display panel.

The foregoing and/or other aspects of the present general inventive concept are also achieved by providing a display apparatus, comprising a display panel to display an image thereon, a light sensor to sense light emitted to a surface of the display panel, a first supersonic wave sensor disposed adjacent to the light sensor to sense a supersonic wave emitted to the surface of the display panel at the same position on the display panel as the light, a second supersonic wave sensor disposed a predetermined distance apart from the first supersonic to sense the supersonic wave emitted to the surface of the display panel, and a controller to determine the position on the surface of the display panel at which the light and the supersonic wave are emitted according to the sensed light and the sensed supersonic wave.

The foregoing and/or other aspects of the present general inventive concept are also achieved by providing a display apparatus, comprising a display panel to display an image thereon, a light sensor to detect light emitted to a position on a surface of the display panel, a first supersonic wave sensor disposed adjacent to the light sensor to detect a supersonic wave emitted to the position on the surface of the display panel to determine a distance from the position on the surface of the display panel to the first supersonic sensor and the light sensor based on detection times of the light sensor and the first supersonic sensor, and a second supersonic wave sensor disposed a predetermined distance apart from the first supersonic sensor to detect the supersonic wave emitted to the position of the surface of the display panel to determine a relative distance of the position on the surface of the display panel to the first and second supersonic wave sensors.

The foregoing and/or other aspects of the present general inventive concept are also achieved by providing a pen unit usable with a display apparatus having a display panel, a light sensor, and first and second supersonic wave sensors one of which being disposed adjacent to the light sensor and the other one of which space apart from the light sensor, the pen unit comprising a light generator to emit light toward a surface of the display panel, and a supersonic wave generator to emit a supersonic wave toward the surface of the display panel.

The foregoing and/or other aspects of the present general inventive concept are also achieved by providing a method of controlling a display apparatus usable with a pen unit to emit light and a supersonic wave to a display panel of the display apparatus, comprising sensing the light emitted by the pen unit from a first sensing position at a first sensing time, sensing the supersonic wave emitted by the pen unit from the first sensing position at a second sensing time, sensing the supersonic wave emitted by the pen unit from a second position space a predetermined distance apart from the first position at a third sensing time, and calculating a position of the pen unit on the display panel according to the first second and third sensing times.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a perspective view illustrating a display apparatus according to an embodiment of the present general inventive concept;

FIG. 2 is a partial exploded perspective view illustrating the display apparatus of FIG. 1;

FIG. 3 is a control block diagram illustrating the display apparatus of FIG. 1; and

FIG. 4 is an operational perspective view illustrating the display apparatus of FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

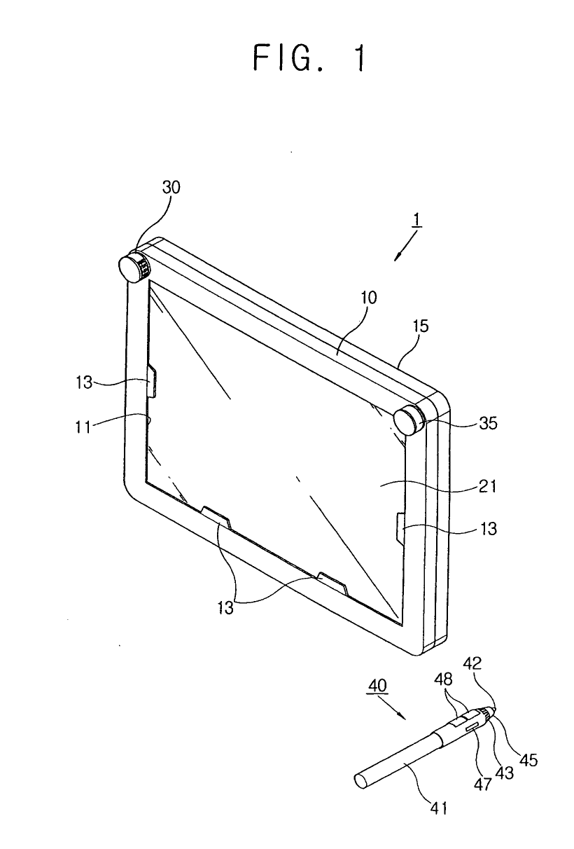

FIGS. 1-3 illustrate a display apparatus 1 according to an embodiment of the present general inventive concept. Referring to FIGS. 1 through 3, the display apparatus 1 comprises a display panel 20 to display a picture thereon, a front cover 10 and a rear cover 15 to support the display panel 20, a pen unit 40 provided to be movable on the display panel 20 and having a light generator 45 provided to generate light and a supersonic wave generator 43 provided to emit a supersonic wave, a light sensor 31 provided at the front cover 10 to detect the light emitted from the light generator 45, a first supersonic wave sensor 33 provided at the front cover 10 to detect the supersonic wave emitted from the supersonic wave generator 43 and disposed adjacent to the light sensor 31, a second supersonic wave sensor 36 provided at the front cover 10 to detect the supersonic wave emitted from the supersonic wave generator 43 and spaced apart from the first supersonic wave sensor 33, and a controller 50 to receive a detecting signal from each of the first supersonic wave sensor 33, the second supersonic wave sensor 36, and the light sensor 31, and to detect position information of the pen unit 40 based on the received detecting signals.

The front cover 10 is provided in front of the display panel 20, and provided with an opening 11 to expose a display surface of the display panel 20. The front cover 10 is coupled with the display panel 20 and the rear cover 15 by a screw or the like. The front cover 10 is provided with first and second sensor housings 30 and 35 to accommodate the light sensor 31 and the first and second supersonic wave sensors 33 and 36.

The display panel 20 may be provided as a flat display panel, such as a liquid crystal display (LCD) or a plasma display panel (PDP). A driving circuit (not shown) may be provided at a rear portion of the display panel 20 to drive the display panel 20. A protection plate 21 may be attached to the display surface of the display panel 20 to protect the display panel 20 from contact with a nib 42 of the pen unit 40 (to be described later).

It is possible that the protection plate 21 is provided as a transparent material, such as vinyl, such that the picture displayed on the display panel 20 is visible therethrough. The protection plate 21 is detachably supported by one or more protection plate supporters 13 which are provided at the front cover 10.

The protection plate supporters 13 project from the front cover 10 in a central direction of the display panel 20 to detachably support the protection plate 21. At least one protection plate supporter 13 may be provided at each side of the opening 11 of the front cover 10. Alternatively, the protection plate supporters 13 may be provided on all but one of the sides of the opening 11 to support the protection plate 21 such that the protection plate can be removed therefrom without difficulty. Accordingly, when using the tablet function, a user may insert the protection plate 21 between the display panel 20 and the protection plate supporters 13 to support the protection plate 21 in front of the display surface of the display panel 20. When not using the tablet function, the user may remove the protection plate 21 from the protection plate supporters 13 without difficulty.

The first and second sensor housings 30 and 35 project from the front cover 10 in a forward direction, i.e., away from the display panel 20. The first sensor housing 30 accommodates the light sensor 31 and the first supersonic wave sensor 33, and the second sensor housing 35 accommodates the second supersonic wave sensor 36.

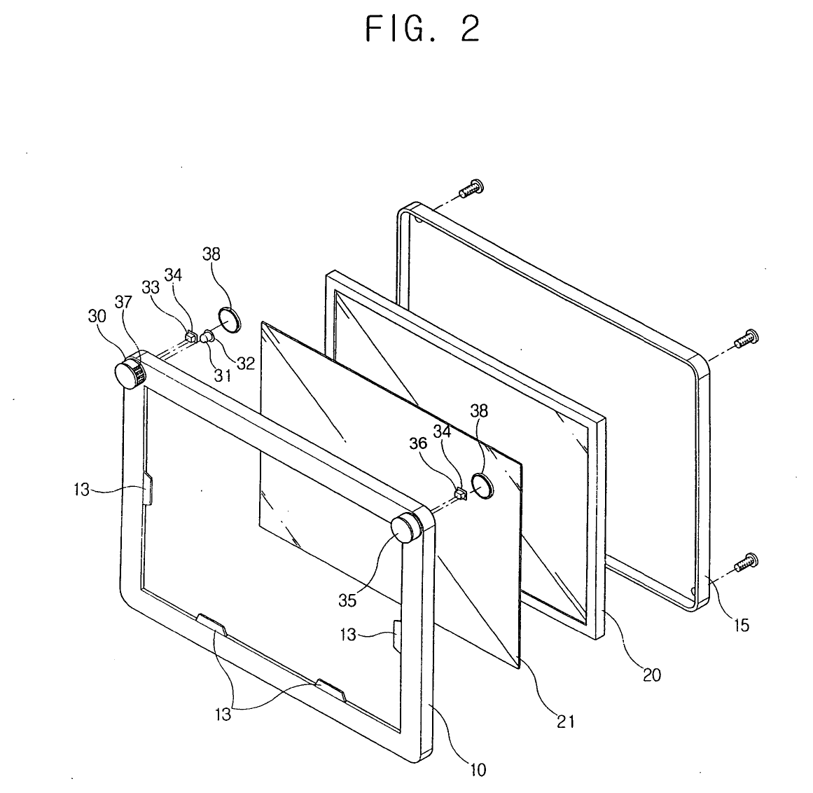

As illustrated in FIGS. 1 and 2, the first sensor housing 30 may be provided at an upper right part of the front cover 10. Alternatively, the first sensor housing 30 may be provided at various parts, such as an upper left part, a lower part, etc., to allow the light sensor 31 and the first supersonic wave sensor 33 accommodated therein to receive the light and the supersonic wave from the pen unit 40.

As illustrated in FIGS. 1 and 2, the second sensor housing 35 may be provided at an upper left part of the front cover 10. Alternatively, the second sensor housing 35 may be provided at various parts, such as an upper right part, a lower part, etc., to allow the second supersonic wave sensor 36 accommodated therein to receive the supersonic wave from the pen unit 40. The first and second sensor housings 30 and 35 may be provided as a single housing, if the first and second supersonic wave sensors 33 and 36 are spaced apart within the single housing. A plurality of penetrating openings 37 are provided in the first sensor housing 30 and the second sensor housing 35 to receive at least one of the light and the supersonic wave from the pen unit 40. A cover member 38 is provided at a rear surface of each of the first and second sensor housings 30 and 35 to support at least one of the light sensor 31 and the first and second supersonic wave sensors 33 and 36, and to cover the first and the second sensor housings 30 and 35 by being coupled to a rear surface of the front cover 10 by a screw or the like.

The light sensor 31 detects the light emitted from the light generator 45 of the pen unit 40. For example, the light sensor 31 may be provided as an infrared ray sensor. Alternatively, the light sensor 31 may be provided as various other light sensors. The light sensor 31 is mounted with a light sensor driving substrate 32 to drive the light sensor 31. The light sensor driving substrate 32 may be supported by the cover member 38 of the first sensor housing 35.

The first supersonic wave sensor 33 detects the supersonic wave emitted from the supersonic wave generator 43 of the pen unit 40. The first supersonic wave sensor 33 is adjacent to the light sensor 31 to measure a distance from the pen unit 40 by using a time difference between when the light sensor 31 detects the light emitted from the light generator 45 and when the first supersonic wave sensor 33 detects the supersonic wave emitted from the supersonic wave generator 43. That is, the first supersonic wave sensor 33 is accommodated in the first sensor housing 30 to be adjacent to the light sensor 31. Because the light and the supersonic wave have different predetermined velocities, the distance from the pen unit 40 can be calculated based on the difference between the times at which the light is detected by the light sensor 31 and the supersonic wave is detected by the first supersonic wave sensor 33.

The second supersonic wave sensor 36 detects the supersonic wave emitted from the supersonic wave generator 43 of the pen unit 40, together with the first supersonic wave sensor 33. The second supersonic wave sensor 36 is spaced apart from the first supersonic wave sensor 33 to measure a relative distance from the pen unit 40 by using a time difference between when the first supersonic wave sensor 33 senses the supersonic wave and when the second supersonic wave sensor 36 senses the supersonic wave. That is, the second supersonic wave sensor 36 is accommodated in the second sensor housing 35 to be spaced apart from the first supersonic wave sensor 33. A supersonic wave sensor driving substrate 34 is mounted to each of the first supersonic wave sensor 33 and the second supersonic wave sensor 36 to drive the respective first and second supersonic wave sensors 33 and 36, and may be supported by the cover member 38 of the respective first and second sensor housings 30 and 35.

The pen unit 40 comprises a fan main body 41 which is shaped like a pen to be grabable by a user, the nib 42 projecting from a first side of the fan main body 41 to contact the display panel 20, and the light generator 45 and the supersonic wave generator 43 (described above) provided on an upper part of the nib 42.

The light generator 45 can emit infrared rays to be detected by the light sensor 31 without difficulty. The supersonic wave generator 43 emits the supersonic wave to be detected by the first supersonic wave sensor 33 and the second supersonic wave sensor 36 without difficulty.

A control button 47 is provided at the fan main body 41 to turn on/off the light generator 45 and the supersonic wave generator 43. For example, while a user is pressing the control button 47, the light generator 45 and the supersonic wave generator 43 may operate. Further, if the user presses the control button 47 once, the light generator 45 and the supersonic wave generator 43 may operate, and if the user presses the control button 47 once again, then the light generator 45 and the supersonic wave generator 43 may stop operating. A pair of adjusting buttons 48 may be provided in the fan main body 41 to allow the pen unit 40 to perform an operation of controlling a point displayed on the display panel 20, similar to the operation of a mouse.

The controller 50 may receive the detecting signal from each of the first supersonic wave sensor 33, the second supersonic wave sensor 36, and the light sensor 31, and calculate the distance from the pen unit 40 to the first sensor housing 30 based on the detecting signals received from the light sensor 31 and the first supersonic wave sensor 33. The controller 50 may also calculate the relative distance ratio from the pen unit 40 to the first sensor housing 30 and the second sensor housing 35 based on the detecting signals from the first supersonic wave sensor 33 and the second supersonic wave sensor 36. Accordingly, two-dimensional position information of the pen unit 40 on the display panel 20 may be calculated since the distance between the first sensor housing 30 and the second sensor housing 35 is fixed. The detecting signals received from the supersonic wave sensor 33, the second supersonic wave sensor 36, and the light sensor 31 may include times at which the first and second supersonic wave sensor detect the supersonic wave and the light sensor 31 detects the light. The controller 50 may transmit the detected position information of the pen unit 40 to a video signal control apparatus 60 which controls a video signal of the display panel 20 to display movement of the pen unit 40 on the display panel 20. According to an embodiment of the present general inventive concept, the controller 50 may be built into the display apparatus 1. Alternatively, the controller 50 may be provided in the video signal control apparatus 60, such as a computer main body, providing the video signal to the display apparatus 1. Furthermore, the video signal control apparatus 60 may be provided in the display apparatus 1, or may be connected to the display apparatus 1 as an external apparatus. The video signal control apparatus 60 may comprise, for example, word processor software, drawing software, etc. The video signal control apparatus 60 can transmit the position information of the pen unit 40 to the above software to be displayed on the display panel 20.

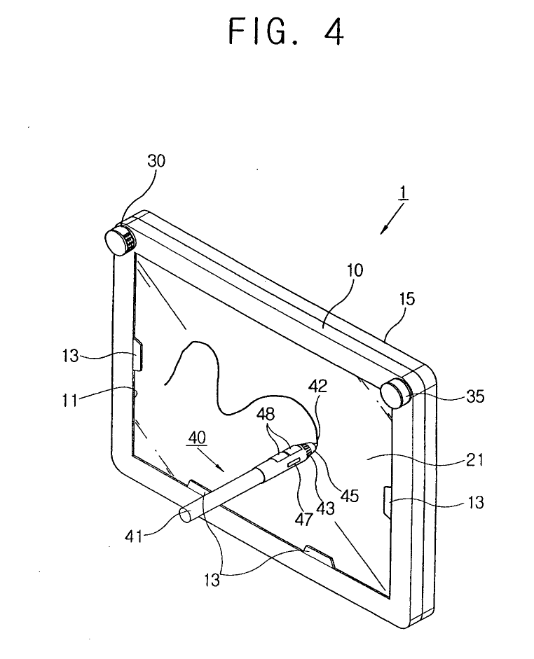

With the above described configuration, operations of the display apparatus 1 according to an embodiment of the present general inventive concept is described below while referring to FIG. 4.

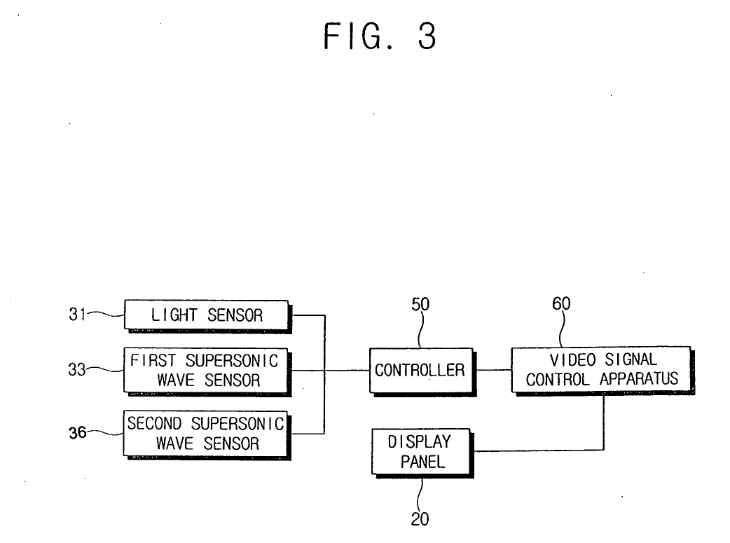

Referring to FIG. 4, while pressing the control button 47 in the pen unit 40, the user can input information on the protection plate 21 with the pen unit 40 when the protection plate 21 is attached in front of the display surface of the display panel 20. The light generator 45 and the supersonic wave generator 43 of the pen unit 40 generate the light and the supersonic waves, respectively, and the light sensor 31 and the first and second supersonic wave sensors 33 and 36 detect the light and the supersonic waves, respectively. The detected signals are transmitted to the controller 50 and used to calculate the position information of the pen unit 40 by the controller 50. The position information detected by the controller 50 is transmitted to the video signal control apparatus 60 (see FIG. 3) or the like and displayed on the display panel 20.

As described above, a display apparatus according to an embodiment of the present general inventive concept may perform a tablet function through a general display panel without having a function such as a touch screen by using a light sensor and a pair of supersonic wave sensors disposed at a front cover, thereby simplifying a configuration by excluding the touch screen, and reducing production costs by using the general display panel.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus comprising a display panel to display a picture thereon, and a front cover and a rear cover to support the display panel, further comprising:
a pen unit movable on the display panel, and comprising a light generator to emit light and a supersonic wave generator to emit a supersonic wave;
a light sensor provided at the front cover to detect the light emitted from the light generator;
a first supersonic wave sensor provided at the front cover to detect the supersonic wave emitted from the supersonic wave generator, and disposed adjacent to the light sensor to measure a distance from the pen unit using a time difference from when the light sensor detects the light and when the first supersonic wave sensor detects the supersonic wave;
a second supersonic wave sensor provided at the front cover to detect the supersonic wave emitted from the supersonic wave generator, and spaced apart from the first supersonic wave sensor to measure a relative distance from the pen unit using a time difference between when the first supersonic wave sensor and the second supersonic wave sensor detect the supersonic wave; and
a controller to receive a detecting signal from each of the first supersonic wave sensor, the second supersonic wave sensor, and the light sensor, and to detect position information of the pen unit based on the received detecting signals.

2. The display apparatus according to claim 1, further comprising:
a first sensor housing provided at the front cover to accommodate the light sensor and the first supersonic wave sensor; and
a second sensor housing provided at the front cover to accommodate the second supersonic wave sensor.

3. The display apparatus according to claim 2, wherein the first sensor housing and the second sensor housing are respectively provided on upper left and right parts of the front cover.

4. The display apparatus according to claim 1, wherein the pen unit further comprises a control button to control operation of the light generator and the supersonic wave generator.

5. The display apparatus according to claim 1, further comprising:
a protection plate provided at a front surface of the display panel to protect the display panel from contact with the pen unit.

6. The display apparatus according to claim 5, further comprising one or more protection plate supporters projecting from the front cover in a central direction of the display panel to detachably support the protection plate at the front surface of the display panel.

7. The display apparatus according to claim 1, wherein the controller transmits the position information of the pen unit to an external video signal control apparatus to control a video signal of the display panel to display movement of the pen unit on the display panel.

8. The display apparatus according to claim 1, further comprising:
a video signal control unit to transmit a video signal to the display panel to display the picture thereon, to receive the position information of the pen unit from the controller, and to control the video signal transmitted to the display panel according to the received position information.

9. A display apparatus, comprising:
a display panel to display an image thereon;
a light sensor to sense light emitted to a surface of the display panel;
a first supersonic wave sensor disposed adjacent to the light sensor to sense a supersonic wave emitted to the surface of the display panel at the same position on the display panel as the light;
a second supersonic wave sensor disposed a predetermined distance apart from the first supersonic to sense the supersonic wave emitted to the surface of the display panel; and
a controller to determine the position on the surface of the display panel at which the light and the supersonic wave are emitted according to the sensed light and the sensed supersonic wave.

10. The display apparatus according to claim 9, wherein the controller calculates a distance from the position at which the light and the supersonic wave are emitted to a position of the light sensor and the first supersonic wave sensor based on a difference between times at which the light sensor senses the light and the first supersonic wave sensor senses the supersonic wave, calculates a relative distance of the position at which the light and the supersonic wave are emitted from the first and second supersonic wave sensors based on a difference between times at which the first and second supersonic wave sensors sense the supersonic wave, and calculates the position at which the light and the supersonic wave are emitted based on the distance from the position at which the light and the supersonic wave are emitted to the position of the light sensor and the first supersonic wave, the relative distance of the position at which the light and the supersonic wave are emitted from the first and second supersonic waves, and the predetermined distance between the first and second supersonic wave sensors.

11. The display apparatus according to claim 9, wherein the controller controls the display panel to modify the image displayed thereon based on the determined position at which the light and the supersonic wave are emitted.

12. The display apparatus according to claim 9, wherein the controller transmits position information corresponding to the position at which the light and the supersonic wave are emitted to an external video signal control apparatus, and the display panel is controller by the video signal control apparatus to modify the image displayed thereon based on the position information.

13. The display apparatus according to claim 9, wherein the light sensor comprises:
an infrared ray sensor to detect infrared rays.

14. A display apparatus, comprising:
a display panel to display an image thereon;
a light sensor to detect light emitted to a position on a surface of the display panel;
a first supersonic wave sensor disposed adjacent to the light sensor to detect a supersonic wave emitted to the position on the surface of the display panel to determine a distance from the position on the surface of the display panel to the first supersonic sensor and the light sensor based on detection times of the light sensor and the first supersonic sensor; and
a second supersonic wave sensor disposed a predetermined distance apart from the first supersonic sensor to detect the supersonic wave emitted to the position of the surface of the display panel to determine a relative distance of the position on the surface of the display panel to the first and second supersonic wave sensors.

15. A method of controlling a display apparatus usable with a pen unit to emit light and a supersonic wave to a display panel of the display apparatus, comprising:
sensing the light emitted by the pen unit from a first sensing position at a first sensing time;
sensing the supersonic wave emitted by the pen unit from the first sensing position at a second sensing time;
sensing the supersonic wave emitted by the pen unit from a second position space a predetermined distance apart from the first position at a third sensing time; and
calculating a position of the pen unit on the display panel according to the first second and third sensing times.

16. The method according to claim 15, wherein the calculating of the position of the pen unit on the display panel, comprises:
calculating a distance from the pen unit to the first position based on the first and second sensing times;
calculating a relative distance from the pen unit to the first and second positions based on the second and third sensing times; and
calculating the position of the pen unit based on the distance from the pen unit to the first position, the relative distance from the pen unit to the first and second positions, and the predetermined distance between the first and second positions.

17. The method according to claim 15, further comprising:
modifying an image displayed on the display panel based on the calculated position of the pen unit on the display panel.
